(19) United States
(12) Patent Application Publication
(10) Pub. No.: US 2020/0065460 A1
(43) Pub. Date: Feb. 27, 2020

(54) METHOD AND COMPUTER READABLE STORAGE MEDIUM FOR REMOTE INTERVIEW SIGNATURE

(71) Applicant: Ping An Technology (Shenzhen) Co., Ltd., Guangdong (CN)

(72) Inventor: Hua NIU, Guangdong (CN)

(73) Assignee: Ping An Technology (Shenzhen) Co., Ltd., Guangdong (CN)

(21) Appl. No.: 16/466,286

(22) PCT Filed: Feb. 12, 2018
(86) PCT No.: PCT/CN2018/076562

§ 371 Date: Jun. 3, 2019

(30) Foreign Application Priority Data
Dec. 1, 2017 (CN) 201711258091.9

(51) Int. Cl. G06F 21/32; G06K 9/00; G06F 21/64

(52) U.S. Cl. CPC G06F 21/32; G06F 21/64; G06K 9/00181; G06K 9/00174

(57) ABSTRACT

The application discloses a method for remote interview signature, an electronic device and a computer-readable medium, comprising steps of: step 01, the client end inquiring whether there is an interview signature task, if so, then going to step 02, if not, exits; Step 02, the user terminal sending the interview signature request to the agent end, the interview signature request including the user information and the service information, the agent end confirming the user information and the service information; Step 03, the agent end authenticating the user, if the authentication passes, then going to step 04, and if the authentication fails, the user is reminded to go to the counter to handle the interview signature; Step 04, the agent end sending the face tag file to the user terminal, the signature file being named and archived at the agent end. user terminal.

This present disclosure declares priority of the Chinese patent application with number CN2017112580919, file on Dec. 1, 2017, entitled “Method, electronic device and computer readable storage medium for remote interview signature”. Entire content of the Chinese patent application is incorporated in the present disclosure by reference.

### BACKGROUND

### Technical Field

The present disclosure relates to a field of contract interview signature, in particular to a method for remote interview signature and computer readable storage medium.

### Background Information

A kind of social industries represented by financial industries such as banking, securities, insurance and so on, when providing business to public, need to check true identity of the parties, that is, need work in the verification of the real-name system. Existing way requires the parties themselves to go to the counter, provide valid personal identification documents, and express their true wishes and to sign relevant documents, that is, “interview signature”. With the vigorous development of the Internet, all kinds of traditional industries are facing the transformation, the original offline person-to-person face to face business is gradually migrating to the network to be completed remotely, which can greatly save labor and the cost of service center. However, how to confirm the true identity of people in the virtual Internet has become the biggest problem in the process of transformation.

### SUMMARY

To solve the problems, the present disclosure provides a method for remote interview signature, comprising the steps of:

Step 01, a user terminal inquiring if there is an interview signature task, if so, then going to step 02, if not, then ending the method;

Step 02, the user terminal sending interview signature request to the agent end, wherein the interview signature request includes user information and business information, and the agent end confirming the user information and the business information;

Step 03, the agent end carrying out authentication on user, if the authentication is passed, then entering Step 04; if the verification is not passed, reminding the user to go to the counter for the interview signature;

Step 04, the agent end sending interview signature document to the user terminal, naming and archiving the interview signature document after signed.

The present disclosure also provides an electronic device comprising a memory and a processor, wherein said memory is for storing a remote interview signature system executed by the processor, the remote interview signature system comprising:

an interview signature task query module, for querying if there is an outstanding interview signature task by the user terminal, if so, the user terminal sending corresponding interview signature request to an interview signature request processing module at the agent end, wherein the interview signature request includes user information and business information;

the interview signature request processing module, for allocating the interview signature request and checking the user information and business information by the agent end, including an interview signature allocation sub-module and an interview signature information check sub-module, wherein the interview signature allocation sub-module is for allocating the interview signature request to a corresponding agent according to a preset allocation strategy, the interview signature information check sub-module is for performing information check on the user information and business information according to the user's ID or ID number;

an authentication module, for verifying identity of the user;

a user signature module, for signing and confirming the interview signature document by the user.

To achieve above object, the present disclosure also provides a computer-readable storage medium in which a remote interview signature system is stored, and the remote interview signature system can be executed by at least one processor, to enforce following steps:

Step 01, a user terminal inquiring if there is an interview signature task, if so, then going to step 02, if not, then ending the method;

Step 02, the user terminal sending interview signature request to the agent end, wherein the interview signature request includes user information and business information, and the agent end confirming the user information and the business information;

Step 03, the agent end carrying out authentication on user, if the authentication is passed, then entering Step 04; if the verification is not passed, reminding the user to go to the counter for the interview signature;

Step 04, the agent end sending interview signature document to the user terminal, naming and archiving the interview signature document after signed.

The details of one or more embodiments of present disclosure are set forth in the accompanying drawings and the description below. Other potential features, objects, and advantages of the present disclosure will become apparent from the description, the drawings, and the claims.

### BRIEF DESCRIPTION OF THE DRAWINGS

In order to more clearly illustrate the embodiments of the present disclosure or the technical solutions in the prior art, the drawings to be used in the embodiments or the prior art description will be briefly described below. Obviously, the drawings in the following description are only some of the embodiments of the present disclosure, and those skilled in the art can obtain other drawings based on these drawings without any creative work.

FIG. 1 shows a flowchart of a method for remote interview signature according to an embodiment of the present disclosure;

FIG. 2 shows program modules of a remote interview signature system according to an embodiment of the present disclosure;

FIG. 3 shows program modules of a remote interview signature system according to another embodiment of the present disclosure;

FIG. 4 shows program modules of a remote interview signature system according to another embodiment of the present disclosure;

FIG. 5 shows hardware architecture of an electronic device according to another embodiment of the present disclosure.

### DETAILED DESCRIPTION

The preferred embodiments of the present disclosure are described in detail below in conjunction with the accompanying drawings so that the advantages and characteristics of the present disclosure can be more easily understood by those skilled in the art and the scope of protection of the present disclosure can be more clearly defined.

### Embodiment 1

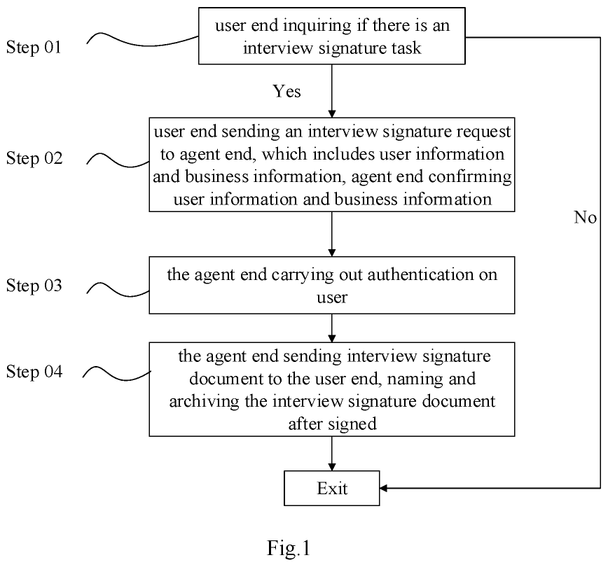

Referring to FIG. 1, which shows a method for remote interview signature, comprising the steps of:

Step 01, a user terminal inquiring if there is an interview signature task, if so, then going to step 02, if not, then ending the method;

In this step, the user for interview signature enters ID number in the user terminal, logs in the interview signature system to inquire if there is an interview signature task, if so, initiates the call request to the agent end to start the interview signature, if not, then exits inquiry page. In detail, the user terminal can be self-help inquiry machine, PC terminal, mobile phone terminal or tablet computer end. By inputting ID number through the user terminal in interview signature inquiry page, it is queried whether there is a interview signature task for loan.

Step 02, the user terminal sending interview signature request to the agent end, wherein the interview signature request includes user information and business information, and the agent end confirming the user information and the business information;

In this step, after receiving interview signature request sent from the user terminal, the agent end acquires the user's basic information according to the user's login identity information, and allocates the user to corresponding agent according to the preset allocation strategy. The agent extracts the business information and personal basic information of the user in the system according to the user's ID or ID number for information check, by an information check sub-module. After the information check is passed, the agent carries out next operation to the incoming call user.

In a preferred embodiment, the preset allocation strategy specifically includes:

Step A, collecting the business data and the behavior data of the agent, calculating business distribution coefficient of the agent and behavior distribution coefficient of the agent respectively, according to the business data and the behavior data of the agent, wherein, the business data of the agent includes the business organization information and service product information of the agent, and the behavior data of the agent includes the fatigue degree evaluation behavior data and the user evaluation behavior data; the fatigue degree evaluation behavior data is obtained according to work and rest time and working period of the agent, and the user evaluation behavior data is obtained according to the evaluation data from the user on the agent; by using big data's decentralization calculation manner, obtaining influence depth and breadth of each business data and behavior data of the agents from big data, obtaining rational score value of each business data for carrying out weighted statistics to get the business allocation coefficient and behavior distribution coefficient of the agent.

Step B, collecting the business data and the behavior data of the user, calculating business distribution coefficient of the user and behavior distribution coefficient of the user respectively, according to the business data and the behavior data of the user, in which the business data of the user includes business product information under name of the user, loan information, whether VIP customer or not, the behavior data of the user includes the behavior data for determining whether the user is a harassing user according to the time and frequency of the incoming call from the user, behavior data of the user behavior evaluation obtained according to the historical evaluation of the user given by the agent; by using big data's decentralization calculation manner, obtaining influence depth and breadth of each business data and behavior data of the users from big data, obtaining rational score value of each business data and behavior data for carrying out weighted statistics to get the business allocation coefficient and behavior distribution coefficient of the users.

Step C, performing a first matching according to the business allocation coefficients of the agent and the user; when a user is calling in, the user is preferentially matched to an agent with a similar business allocation coefficient, and it is judged whether preferentially assigned agent is in idle state, and if so, then starting to answer, if the agent is answering a call from another user, selecting another agent with similar business allocation coefficient and available to answer;

Step D, performing a second matching according to the behavior allocation coefficients of the agent and the user; if there is no agent with similar business allocation coefficient, the user is allocated to an agent with a similar behavior allocation coefficient, and it is judged whether preferentially allocated agent is in idle state, and if so, then starting to answer, if the agent is answering a call from another user, selecting another agent with similar behavior allocation coefficient and available to answer.

Step E, the agent checks whether the business information of the allocated user matches the business information of the user to whom the agent is responsible, if so the incoming call request of the user is accessed, and if not, the call incoming request is sent back to the allocation module for reallocation.

In the embodiment, business allocation is performed according to the business data of the user and the business data of the agent, which is conducive to improving the business matching between the user and the agent, and making the agent more targeted to provide corresponding business services, improving the quality of service and the success rate of business management.

Step 03, the agent end carrying out authentication on user, if the authentication passes, then entering Step 04; if the verification does not pass, reminding the user to go to the counter for the interview signature;

In this step, authentication includes ID verification and face recognition verification. The ID verification includes the identification and extraction of the user's ID validity and user information by using the ID card identification instrument. Face recognition verification includes collecting photos of users on site and conducting face recognition with photo of ID card or on third party identity information network for verification.

In a preferred embodiment, authentication specifically includes:

Step 03-1, the agent end sending an authentication instruction to the user terminal, after the user terminal receiving the instruction, the authentication instrument being turned on at the user terminal, and performing material feeding guidance on the user through the user interface, including reminding the user to put the ID card in the designated area, and adjusting the brightness of the client and other acquisition parameters; the identification instrument scans the ID card to extract the head photo and ID number information on the ID card, and carries out the de-texturing of the head photo; the processed photo and ID number information are sent to a file server at the user terminal and an identification ID number is formed for extracting the photo and information, and the user terminal sends the identification ID number to the agent end; the material feeding guidance includes: detecting the operation process on the user terminal, and sending the feedback instruction to the agent end, and the agent terminal feeds the material guidance file of the next operation to the user terminal according to the feedback instruction.

Step 03-2, the agent end verifying the validity of the ID card information, if verification is passed, entering next step, and if the verification is not passed, reminding going back to the user terminal for re-collection; the agent end obtaining user information corresponding to the ID number from the verification network through the interface connected with the third-party identity verification network, while obtaining ID card information from the user terminal by identifying the ID number; comparing the validity period of the ID card collected with the information on the verification network to determine whether the ID card is within the validity period, comparing user photo from the verification network with collected ID photo of head to verification; if similarity of the two photos exceeds a first threshold, the verification is passed, and if the similarity is lower than the first threshold, the verification is not passed, wherein the first threshold can be 70, and the first threshold can be obtained by statistical analysis of the historical similarity value. This step can improves query efficiency so as to avoid the need to spend much time on authentication and problem of failing to query as ID card has expired. In practical application, in the Step 01, it is also possible to directly determine whether the ID card is in the valid period according to current date of the system after collecting the valid date of the ID card, wherein, the third party identity verification network can be the public security network.

Step 03-3, the agent end carrying out face recognition verification to the user, if the verification is passed, entering the next step, if the verification is not passed, the user being reminded to go to the counter for verification with a valid certificate; after the ID verification is passed, the agent end activating face recognition sub-module to perform the face recognition verification on the user; the agent end sending the instruction to start the high camera to the user, after receiving the instruction, the user turning on the high cameral, and sending text and voice operation prompt to the user via the user interface; the user capturing facial image on the site by the prompt, after that, sending photo back to the agent end; a face recognition module at the agent end comparing the facial image with user head photo from the verification network; if the similarity from matching results of the two exceeds a second threshold value, the verification is passed; if the similarity is lower than the second threshold value, the prompt verification is not passed, then the agent end agent reminding the user to carry out the face recognition verification second time; if it still fails to pass, the user being reminded to go to the counter to handle the interview signature with the valid certificate, wherein the second threshold can be obtained by statistical analysis of the historical data and, preferably, the second threshold is 60. Face recognition comparison includes face acquisition, face feature location, face feature extraction and face feature similarity comparison.

The face acquisition includes marking the face coordinates and detecting whether there is a face, evaluating the shooting quality, and taking a screenshot of the facial image, concretely, includes marking the face coordinate after opening the camera and detecting whether there is a face, evaluating the shooting quality, and taking a screenshot of the face. Detecting whether there is a face can be based on the shown coordinates and the pre-stored location range of the facial features to determine whether there are positive facial features and complete facial contours. Evaluating the shooting quality may include a head angle assessment, a brightness assessment, and a dynamic blur assessment; the head angle evaluation include judging whether the head has an upper and lower declination angle within e.g., 15°, a left and right declination angle within e.g., 15°, a rotation angle within e.g., 20°. If above are all met, the head angle assessment is considered passed. the brightness assessment includes judging whether the brightness is within for example [80, 200], and if so, the brightness assessment is considered to be passed; The dynamic blur evaluation includes judging whether the ambiguity value is less than 0.2, if so, it is considered to the dynamic fuzzy evaluation passed. If quality assessment does not meet the requirements, the user should be prompted to adjust the content, such as “please straighten the head”, “please lower your head”, “please stay away from the camera”, if the brightness evaluation does not meet the requirements, it can also be adjusted by a flash set next to the camera. In addition, an assessment of the quality of the photo may include judging whether the user is wearing thick rimmed glasses, sunglasses, whether hair covering the ears or other features.

The face feature location includes locating a plurality of features of a face containing organs, including locating a plurality of features of a face including eyebrows, eyes, nose, mouth and the like.

The face feature extraction comprises extracting a plurality of feature information of each feature according to a preset extraction rule.

The face feature similarity comparison comprises comparing a plurality of extracted feature information one by one with the feature information of an identity card head photo, and obtaining a second comparison threshold, wherein, face features can include the length, slope, gray difference and other parameters to represent the three-dimensional size of each part, tilt direction, and the distance from other parts, and face features can be a set of feature information. Face feature similarity comparison can compare two sets of feature information one by one, and each type of feature information is defined with a certain weight, for example, the weight of important feature information is large, and the weight of secondary feature information is relatively small. It is also possible to define some of the characteristic information that must be consistent as a necessary condition for judging to be verified.

In the embodiment, the identification card verification and face recognition verification are combined to identify and verify the identity information of the user and the authenticity of the field user, thereby improving the authenticity of the identity verification of the face tag user, preventing others from impersonating users to handle business.

Step 04, the agent end sending interview signature document to the user terminal, naming and archiving the interview signature document after signed.

In this step, the user may choose to sign the paper document or the electronic document, wherein the paper signature is the user's signature on the paper application material for interview signature, and the signed material is placed under the high camera and sent back to the agent end. The agent end names and files the interview signature material. The electronic signature is to load and send the electronic contract list which needs the user's signature to the user terminal, and the user scans QR code on the contract to sign for confirmation.

In a preferred embodiment, a paper signature includes following processes: a user signs or seals on a corresponding signature part on an existing paper contract document, and all contract documents and signature pages are photographed under a high camera at the user terminal; after confirming the photo is clear and complete, it is sent back to the agent end, which then check whether the uploaded photo file content is consistent with the contract list, after confirm it, the signed material, contract, user face photos, ID photos archived and saved.

In a preferred embodiment, the electronic signature comprises following processes: the agent end checks the user information and generates the electronic contract document to be signed, sends the generated electronic contract document to the user terminal; the user scans the QR code on the document and signs it for confirmation, and sends it to the agent, which confirms that the signed contract document is correct, and then files and saves it.

In the embodiment, an electronic signature is added on the basis of the paper signature, which is convenient for the user to continue the face-signing procedure without the paper-based contract document, avoids the interruption of the face-signing, and improves the efficiency and the success rate of the business management.

### Embodiment 2

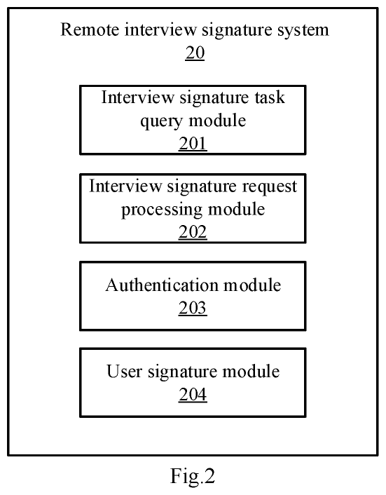

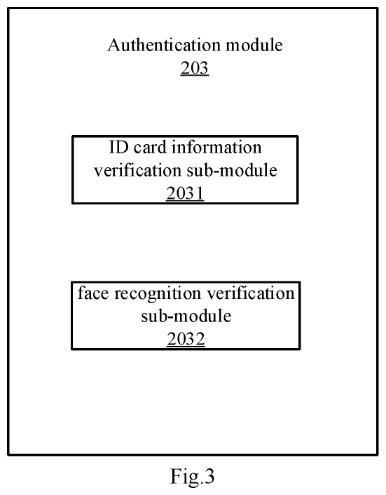

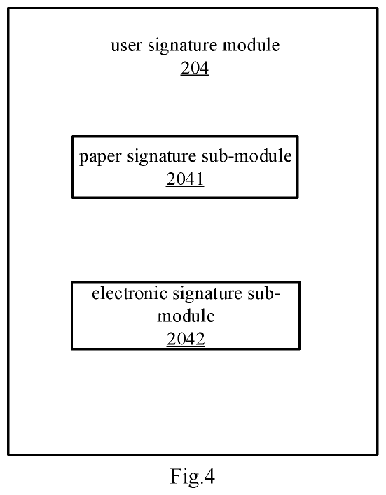

Referring to FIGS. 2 to 4, a remote interview signature system 20 is illustrated. In this embodiment, the remote interview signature system 20 is divided into one or more program modules, which are stored in a storage medium, and executed by one or more processors to complete the application. A program module for the purpose of the present disclosure is a series of computer program instruction segments capable of performing a specific function, which is more suitable than the program itself to describe the execution of the remote interview signature system 20 in a storage medium. The following descriptions will introduce in detail the functions of each program module in this embodiment:

an interview signature task query module 201, for querying if there is an outstanding interview signature task by the user terminal, if so, the user terminal sending corresponding interview signature request to an interview signature request processing module at the agent end, wherein the interview signature request includes user information and business information; in this query module, the user for interview signature enters ID number in the user terminal, logs in the interview signature system to inquire if there is an interview signature task, if so, initiates the call request to the agent end to start the interview signature, if not, then exits inquiry page. In detail, the user terminal can be self-help inquiry machine, PC terminal, mobile phone terminal or tablet computer end. By inputting ID number through the user terminal in interview signature inquiry page, it is queried whether there is a interview signature task for loan;

an interview signature request processing module 202, for allocating the interview signature request and checking the user information and business information, including an interview signature allocation sub-module and an interview signature information check sub-module, wherein the interview signature allocation sub-module is for allocating the interview signature request to a corresponding agent according to a preset allocation strategy, the interview signature information check sub-module is for performing information check on the user information and business information according to the user's ID or ID number; after the task query module acknowledges that there is an interview signature task, the user initiates an interview signature call request to the agent terminal through video or call; after the agent end receives the interview signature call request sent by the user terminal, user profile is obtained based on the identity information from user login, the interview signature request is allocated to a corresponding agent according to a preset allocation strategy; after the user information is checked without error by the agent, next operation is entered.

an authentication module 203, for verifying identity of the user;

In a preferred embodiment, the identity authentication module includes an ID card information verification sub-module 2031 and a face recognition verification sub-module 2032.

The ID card information verification sub-module 2031 is for verifying whether ID card information of the user is valid and whether the ID card information is consistent with the ID card information of the third-party verification network. After the ID card information verification sub-module receives the authentication instruction, the authentication instrument at user terminal is turned on, and material feeding guidance is performed on the user through the user interface, including reminding the user to put the ID card in the designated area, and adjusting the brightness of the client and other acquisition parameters; the identification instrument scans the ID card to extract the head photo and ID number information on the ID card, and carries out the de-texturing of the head photo; the processed photo and ID number information are sent to a file server at the user terminal and an identification ID number is formed for extracting the photo and information, and the user terminal sends the identification ID number to the agent end; the agent end obtains user identity information corresponding to the ID number from the verification network through the interface connected with the third-party identity verification network, while obtaining ID card information from the user terminal by identifying the ID number, then comparing the user identity information on the verification network with collected ID card information.

The face recognition verification sub-module 2032 is for verifying whether the facial image of the user for interview signature on the user terminal is consistent with the photo on the third-party ID verification network. After authentication is passed, the agent end activates the face recognition verification sub-module to perform face recognition verification on the user; the agent end sends the instruction to start the high camera to the user, after receiving the instruction, the user turns on the high cameral, and sends text and voice operation prompt to the user via the user interface; the user captures facial image on the site by the prompt, after that, sends photo back to the agent end; a face recognition module at the agent end compares similarity of the facial image with user head photo from the verification network;

a user signature module 204, for signing and confirming the interview signature document by the user.

In a preferred embodiment, the user signature module includes a paper signature sub-module 2041 and an electronic signature sub-module 2042. The paper signature sub-module 2041 is for reminding the user to sign at the corresponding position of the paper contract and collecting the contract and signature information to be sent back to the agent end. The electronic signature sub-module 2042 is used for the user to scan a two-dimensional code on the electronic contract document generated from the agent end for the electronic page signature and send the signature back to the agent end for confirmation.

### Embodiment 3

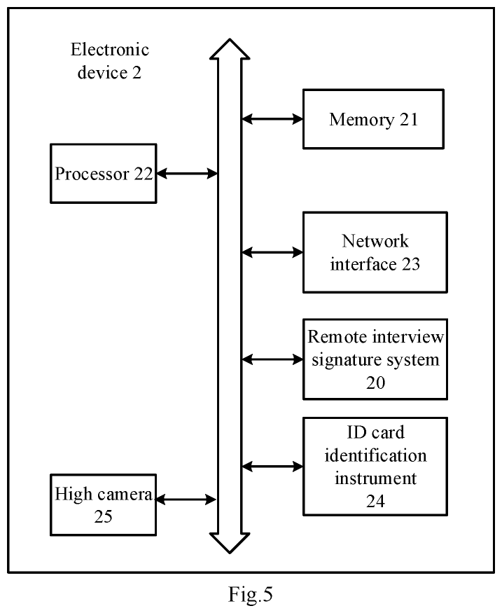

Referring to FIG. 5, this embodiment provides an electronic device, a schematic diagram of the hardware architecture of an electronic device of the embodiment of the present disclosure is shown. In this embodiment, the electronic device 2 is a device capable of automatically performing numerical calculations and/or information processing according to predefined or stored instructions. For example, it can be a smartphone, tablet, laptop, desktop computer, rack server, blade server, tower server, or cabinet server including stand-alone servers. Or a cluster of multiple servers), and so on. As shown, the electronic device 2 includes, but is not limited to, a memory 21, a processor 22, a network interface 23, ID card identification instrument 24, high camera 25 and the a remote interview signature system 20 that can be communicated with each other through a system bus, in which:

The memory 21 includes at least one type of computer-readable storage medium. The readable storage medium includes flash memory, hard disk, multimedia card, card type memory (e.g., SD or DX memory, etc.), random access memory (RAM), static random access memory (SRAM), read only memory (ROM), electrically erasable. Programmable read-only memory (EEPROM), programmable read-only memory (PROM), magnetic memory, magnetic disk, optical disk, etc. In some embodiments the memory 21 may be an internal storage module of the electronic device 2 such as a hard disk or memory of the electronic device 2. In other embodiments, the memory 21 may also be an external storage device of the electronic device 2, such as a plugged hard disk provided on the electronic device 2, an intelligent memory card (Smart Media Card, SMC), secure digital (Secure Digital, SD) card, a flash memory card (Flash Card), and the like. Of course the memory 21 may also include both an internal storage module and an external storage device of the electronic device 2. In this embodiment, the memory 21 is generally used to store an operating system and various types of application software installed in the electronic device 2 such as the program code of the remote interview signature system 20 and the like. In addition, the memory 21 may also be used to temporarily store various types of data that have been or will be outputted.

The processor 22 may in some embodiments be a central processor (CPU), a controller, a microprocessor, or other data processing chip. The processor 22 is generally used to control the overall operation of the electronic device 2 such as performing control and processing related to data interaction or communication with the electronic device 2. In this embodiment, the processor 22 is used to run program code stored in the memory 21 or process data such as running the remote interview signature system 20 or the like.

The network interface 23 may include a wireless network interface or a wired network interface which is generally used to establish a communication connection between the electronic device 2 and other electronic devices. For example, the network interface 23 is used for connecting the electronic device 2 to an external terminal via a network establishing a data transmission channel and a communication connection between the electronic device 2 and the external terminal. The network can be a wireless or wired network such as an enterprise intranet, an Internet, a Global System of Mobile communication (GSM), a Wideband Code Division Multiple Access (WCDMA), a 4G network, a 5G network, a Bluetooth, Wi-Fi, and the like.

It is to be noted that FIG. 5 shows only an electronic device having components 20-25 but it is understood that it is not required to implement all of the shown components and that more or fewer parts can be implemented in lieu thereof.

In this embodiment, the remote interview signature system 20 stored in memory 21 may also be divided into one or more program modules, said one or more program modules being stored in memory 21, and executed by one or more processors (in this embodiment, processor 22) to complete the application.

For example FIG. 2 shows a schematic diagram of a program module of the first embodiment of the remote interview signature system 20, in which the remote interview signature system 20 may be divided into a interview signature task query module 201, a interview signature request processing module 202, an authentication module 203, and a user signature module 204. The program module referred to in the present disclosure refers to a series of computer program instruction segments capable of accomplishing a specific function, and is more suitable than a program to describe the execution process of the remote interview signature system 20 in the electronic device 2. The specific functions of the program module 201-204 have been described in detail in embodiment 2 and are not repeated here.

ID card identification instrument 24 is used for connecting with the authentication module 203 to collect the ID card information placed by the user such as the pre-stored information in the chip of the second-generation ID card.

The high camera 25 is configured to be turned on and off by the authentication module 203 to capture the facial image of the operating terminal device. The high camera 25 can be connected to the electronic device 2 at the user terminal through a USB interface. The user adjusts the shooting angle of the two cameras according to the actual shooting angle, or the agent end sends the command to the control module of the user terminal through the command entrance to control the high camera to do different operations, thus realizing the remote control of the high camera. After taking a picture, the high camera passes it back to the agent end, which chooses whether to readjust the parameters of the camera to obtain the required photos according to the effect of the photos.

In a preferred embodiment it is included a flash 26 configured to be turned on and off by the shooting adjustment subroutine and to be brightness adjusted.

### Embodiment 4

This embodiment provides a computer-readable storage medium. The remote interview signature system 20 is stored on the computer-readable storage medium. When the remote interview signature system 20 is executed by one or more processors, the remote interview signature agent matching system 20 realizes the operation of the remote interview signature agent matching method or electronic device.

Positive effects of the present disclosure lie in that the method in the present disclosure supports multi user terminal access and unified agent end service, which is convenient for the user to realize the communication interaction between the user terminal and the agent end through the way of unified instruction by multiple user terminals, wherein the agent end controls operation of remote interview signature during whole process, improving operation success rate and customer satisfaction of the remote interview signature.

Through the description of the above embodiments it is clear to those skilled in the art that the above embodiments may be implemented by means of software plus the necessary common hardware platform and of course by hardware. But in many cases the former is the better way to do it.

Not limited hereto, any change or substitution which is not the result of creative labor shall be covered by the present disclosure. Therefore, the scope of protection of the present disclosure be subject to the scope of protection limited by the claim.

1. A method comprising:
inquiring via a user terminal if there is an interview signature task in an interview system;
upon determining that there is the interview signature task in the interview system, sending via the user terminal an interview signature request to an agent terminal, wherein the interview signature request includes user information and business information, and the agent terminal is configured to confirm the user information and the business information;
authenticating via the agent terminal a user based on the user information and business information;
if the authentication is successful, sending an interview signature document to the user terminal; and
naming and archiving the interview signature document after the interview signature document is signed.

2. The method of claim 1, wherein inquiring if there is the interview signature task in the interview system includes obtaining ID number of a user to inquiry if there is an interview signature task.

3. The method of claim 1, wherein further comprising after receiving the interview signature request from the user terminal, allocating via the agent terminal the interview signature request to a corresponding agent according to a preset allocation strategy.

4. The method of claim 1, wherein authenticating via the agent terminal the user includes:
collecting ID card information and verifying validity of the ID card information;
collecting photo of the user under interview signature on site, and
performing face recognition by comparing the collected photo with a photo included in the ID card information or a photo obtained from a third-party identity information network.

5. The method of claim 1, wherein further comprising receiving the signed interview signature document from the user terminal prior to naming and archiving the signed interview signature document.

6. The method of claim 1, wherein sending interview signature document to the user terminal includes sending from the agent terminal to the user terminal an electronic contract which needs a user's signature, the contract including a QR code to enable the user to scan for signing.

7. (canceled)

8. (canceled)

9. (canceled)

10. A computer-readable storage medium in which a remote interview signature system is stored, and the remote interview signature system can be executed by at least one processor, to enforce following steps:
inquiring via a user terminal if there is an interview signature task;
upon determining that there is an interview signature task, sending via the user terminal an interview signature request to an agent terminal, wherein the interview signature request includes user information and business information, and the agent terminal is configured to confirm the user information and the business information;
authenticating via the agent terminal a user based on the user information and business information;
if the authentication is successful, sending via the agent terminal an interview signature document to the user terminal and
naming and archiving the interview signature document after the interview signature document is signed.

11. The computer-readable storage medium of claim 10, wherein inquiring if there is the interview signature task in the interview system includes obtaining ID number of a user to inquiry if there is an interview signature task.

12. The computer-readable storage medium of claim 10, wherein further comprising: after receiving the interview signature request from the user terminal, allocating via the agent terminal the interview signature request to a corresponding agent according to a preset allocation strategy.

13. The computer-readable storage medium of claim 10, authenticating via the agent terminal the user includes:
collecting ID card information and verifying validity of the ID card information;
collecting photo of the user under interview signature on site, and
performing face recognition by comparing the collected photo with a photo included in ID card information or a photo obtained from a third-party identity information network.

14. The computer-readable storage medium of claim 10, further comprising receiving the signed interview signature document from the user terminal prior to naming and archiving the signed interview signature document.

15. The computer-readable storage medium of claim 10, sending interview signature document to the user terminal includes sending from the agent terminal to the user terminal an electronic contract which needs a user's signature, the contract including a QR code to enable the user to scan for signing.
